(19) United States
(12) Patent Application Publication
(10) Pub. No.: US 2026/0285779 A1
(43) Pub. Date: Sep. 24, 2026

(54) A Compact Composter Assembly

(71) Applicants: Jayant K Roplekar, Peoria, IL (US); Srujan J Roplekar, Peoria, IL (US); Saya C Patil, Peoria, IL (US)

(72) Inventors: Jayant K Roplekar, Peoria, IL (US); Srujan J Roplekar, Peoria, IL (US); Saya C Patil, Peoria, IL (US)

(21) Appl. No.: 19/088,926

(22) Filed: Mar. 24, 2025

(51) Int. Cl. C05F 17/964; C05F 9/02; C05F 17/993

(52) U.S. Cl. CPC C05F 17/964; C05F 9/02; C05F 17/993

(57) ABSTRACT

A compact composter assembly that allows in-home composting in a simple manner is described. It provides simplified mechanism to shred the organic input material to optimal size, manage excess humidity, aerate the shredded material and mix with existing composting batch and new culture. An integrated sieve to support material pile during composting and an inbuilt tray to remove the collected compost is also described. A method to control humidity and monitor environmental parameters within the assembly are also shown.

### BACKGROUND OF THE INVENTION

The present invention is related to composting which involves, controlled decomposition of organic materials into a nutrient-rich mixture for use as a fertilizer and soil amendment. By controlling the moisture content, temperature and air exposure, with sufficient time organic matter gets decomposed and forms compost. Utilizing this compost for useful purposes, as opposed discarding the raw waste in landfills, is preferable to minimize logistics costs involved in moving the material to landfill, the space landfills occupy and potential expansion they will need. It also recovers residual value from unused food, at the source, especially in the urban setting.

While a large scale composting facilities utilizing complex machinery or large open pits to move and aerate material exist, the separation of compostible materials and transport to these specialized facilities has limited effectiveness. The limiting factors are separation of the waste streams and presenting it to waste collector requires significant effort from the consumer. The transportation, processing of the waste stream incurs costs that can not be recovered easily. The environmental foot print of transportation and processing is another factor to consider. The above approach is mainly relevant to large commercial operations like cafeterias or restaurants.

There have been increasing efforts to increase the ease of composting by consumers at home over the years. In the simplest form, a bucket to collect food scraps and then depositing it in a large outdoor tumbler with existing compost culture and rotating the tumbler to aerate can yield compost. However the effort needed and inefficiency acts as a barrier for adoption of composting by even the most committed consumers. Some of the existing approaches are reviewed in the Prior Art section below.

PRIOR ART

For example, U.S. Pat. No. 3,608,838A to Lundin and Milner describes a comminuter i.e. a grinder or macerator for reducing articles to small particles, which has an upright housing with vertically spaced intake and discharge openings. A spider assembly of rotating blades driven by V-belt and a motor impacts stationary blades to produce the grinding action and water spray to remove small particles.

In patents US20180334412A1 and U.S. Pat. No. 10,906,847B2 to Buzruk et al describe composting device sliding lid with a seal assembly. Another related patent U.S. Pat. No. 10,995,042B2 to Atkinson et al. describe a food recycler including a housing with an access opening to the interior which contains a mixing bin which connects to the output bin. A rotary vibrator with teeth to transfer the food waste from mixing bin to output bin. U.S. Pat. No. 10,822,289B2 to Buzruk et al describes a variation with a funnel assembly and U.S. Pat. No. 10,590,046B2 to Buzruk and Wilcox shows a version with door and fascia.

U.S. Pat. No. 10,759,717B2 to Stearns and Stearns describes a self-regulating compost bin with a window to let sunlight in, and a fan to regulate temperature. Once the temperature reaches a predetermined temperature to alert user to indicate compost is safe to use.

U.S. Pat. No. 10,611,699B2 to Halbleib et al describes a way to estimate height of organic material by comparing torque signature against rotation angle of motor driving mixing paddles.

U.S. Pat. No. 10,023,504B2 to John Hulls shows composting data produced by a system, mainly intended for sanitary waste in a collection tank with insulating walls and a cover with perforated air intake tubes.

U.S. Pat. No. 6,110,733A to Shaun A. Seymour describes a cylindrical rotary composter with baffles and variable speed fan for air induction.

U.S. Pat. No. 6,029,918A to Henric Sundberg describes a composter which is compact and of sufficient capacity to facilitate composting within the home, with a rotating drum with a mechanism to accept waste additions, a water drain and a compost collector.

U.S. Pat. No. 5,429,945A to Stanley M. Shain illustrates a unique architecture using conical disks that adaptively regulates the air and moisture content of an interior chamber to facilitate efficient composting.

U.S. Pat. No. 5,339,974A to Narayan Raghunathan describes an easily transportable domestic composter with tongue and socket connectors such that the two halves may be firmly assembled together or separated without the use of tools.

U.S. Pat. No. 5,127,587A to Harold R. Johnson describes a floor mounted spin chamber connected with a kitchen disposer-grinder for de-watering and collecting ground food scraps that are suitable for garden composts.

While making composting accessible for consumers has been an area of active invention and discussion, the prior art utilizes complex systems with specialized electric drive systems, along with heating systems and fans to regulate temperature and air induction. The complex system elements ultimately serve as potential points of failure. In many cases, the heating element is essentially used to to dry the material and then chop it with a cutter assembly, which is energy intensive and destroys the nutritional value of the compost as a fertilizer or soil amendment. The current systems targeted towards home user that avoid the motor drives and external heat input, do not provide an optimal environment to speed up and simplify the composting process for a home user. The current invention aims to address many of these shortcomings of the prior art.

### SUMMARY OF THE INVENTION

It is an object of this invention to create a compact composter assembly targeted for home user, which allows in-home composting with minimal external energy input especially in the form of heat, while creating optimal environment for composting efficiency and ease of use. A key element of this invention is integrating multiple essential features for the aerobic composting process in a compact space-claim by a novel configuration of the elements. The prerequisites of successful composting, assuming a robust starting culture & reasonable ratio of green (Nitrogen rich) and brown (Carbon rich) raw material are:
1. managing particle size of raw material to be composted
2. air induction and aeration
3. humidity/excess liquid management

The ease of use features important for the wide spread use of composters are:
1. Compactness
2. Ease of adding raw material to be composted, and additional culture
3. Minimal maintenance and intervention during composting process
4. Ease of withdrawing the formed compost
5. A way to monitor progress of the composting process

### BRIEF DESCRIPTION OF DRAWINGS

For a more complete understanding of the invention, references are made to the following description and accompanying drawings:

FIG. 1 shows the overall view of the invented composter assembly.

FIG. 2 is a view of the internals of the assembly to illustrate specific components.

FIG. 3A is a perspective view and FIG. 3B is a sectional view of slicer assembly.

FIG. 4A and FIG. 4B show the air induction mechanism.

FIG. 5 shows the sensors and instrument panel arrangement.

### DETAILED DESCRIPTION OF THE INVENTION

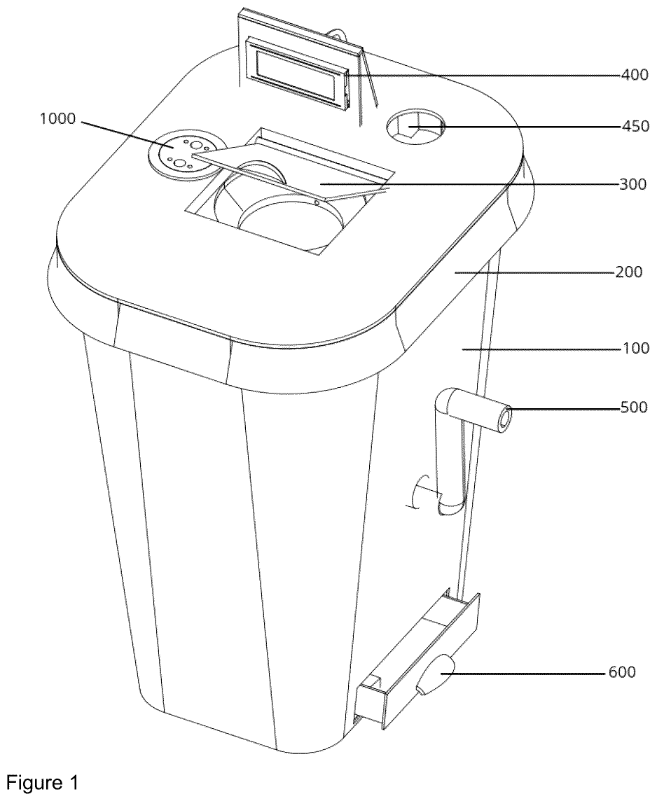

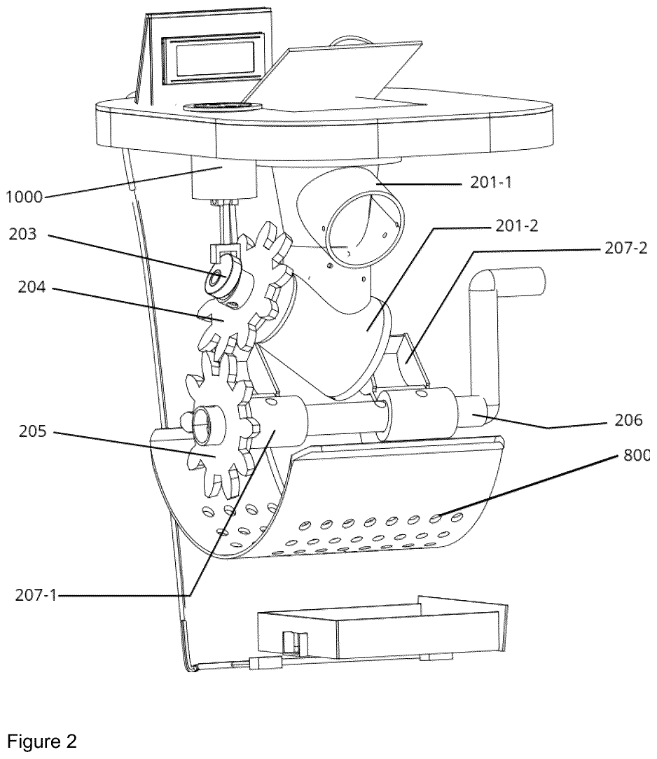

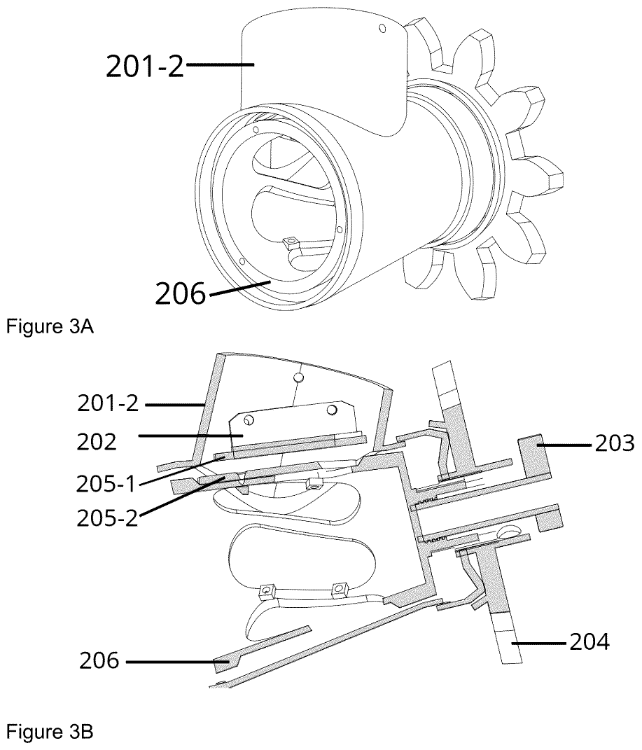

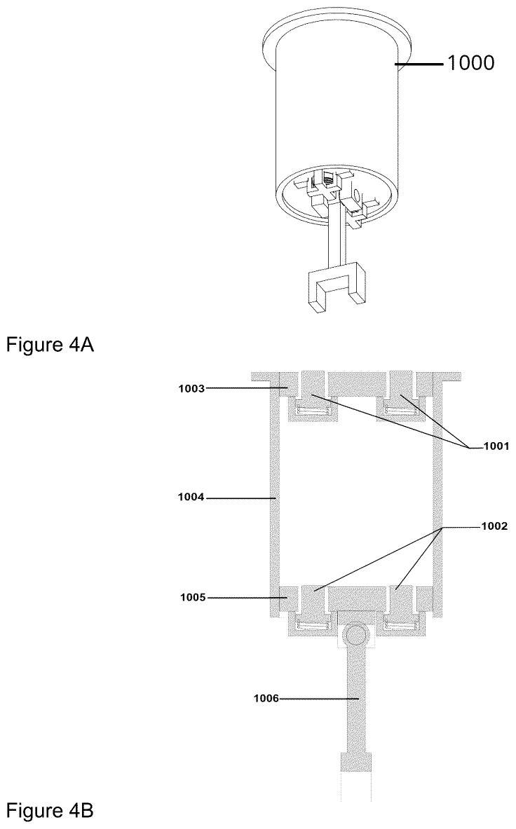

FIG. 1 shows an exemplary arrangement of the current invention. It shows the bin, Element 100, which serves as the housing and main structural member of the invented composter assembly. The other elements of this assembly illustrated are the header, Element 200, the Lid, Element 300, the instrument panel as Element 400 and the receptacle, Element 450 to hold a replaceable cartridge of desiccant material in granular form for humidity management. On the side of composter bin, handle as Element 500 is shown. Element 600 is the compost collector tray that seals against the wall of the composter bin 100. Element 1000 is the air induction assembly, further described in FIG. 4 below.
FIG. 2 illustrates the internals of the composter assembly, where Element 201-1 in the current embodiment is the chute assembly attached to Element 200 via a threaded joint or a bolted joint in conjunction with a slight press fit. The current embodiment also uses Element 201-2, attached to the vertical chute 201-1 to contain on the interior a slicer element 206, described in FIG. 3. The said slicer element is driven by a splined Gear, element 204. Element 204 meshes with another gear element 205, which is attached to a shaft 206. shaft 206 also drives scoops 207-1 and 207-2 which aerate the pile with the rotating motion of the shaft. The shaft itself is externally driven by the handle, Element 500, shown above. The shaft is supported at the both ends by bearing areas which are part of compost bin 100.

The compost bin 100, also has integrated features to support compost pile holder, Element 800, which has perforations that allow it to act as a compost sieve. This view also shows Element 1000, which is the air induction mechanism, further described in FIG. 4 below.

FIG. 3A is a perspective and FIG. 3B is a cross sectional view of the slicer assembly. It consists of the chute 201-2, which has a vertical segment and a segment at an obtuse angle connected to it. It also houses a blocker assembly, Element 202 with a blade element 205 attached to it. The blocker assembly, attached to the vertical wall of the chute, could be screwed in, molded in or a formed metal piece. The slicer element 206 has a cylindrical spline on one end and on the other end forms a clearance joint with Chute 201-2 and has an open end at an incline to deposit the sliced material. The main body of the slicer has elliptical slots and multitude of blades 205-2 to alternate between cutting in conjunction with stationary blade 205-1 and depositing the chopped material in the interior of the bin.

FIG. 4A shows perspective view of the air induction mechanism, element 1000 shown before. FIG. 4B shows a detailed sectional view of the assembly, where, stationary housing Element 1004 and Element 1003, along with movable Element 1005, serving as a piston, form an air pump. The cost effective check valves at either end, elements 1001 and 1002 allow flow of air in one direction, i.e., into the composter. The upper ones, i.e., 1001 open during the suction stroke of the pump and lower ones, 1002 open during the blow-down stroke, otherwise they are substantially closed. This air induction pump's piston is actuated by a connecting rod, Element 1006, which follows the cam, element 203, integrated into the drive mechanism, of the slicer assembly described above.

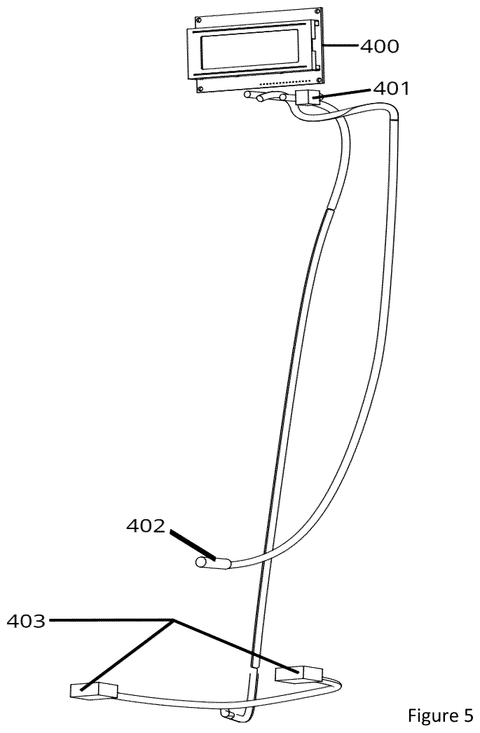

FIG. 5 illustrates an exemplary arrangement of the sensors & instrument panel associated with the invented assembly. Element 400, the instrument panel provides user with visual information on air temperature, compost pile temperature and the humidity of the air. These allow the user to monitor progress of the composting process. It also enables transmitting data wirelessly for further processing. The key elements of the above mentioned sensing system are:
1. The combined temperature and humidity sensor, element 401 to sense air temperature and humidity
2. The temperature probe, element 402 directly measuring the pile temperature.
3. The illustrative arrangement of weight sensor 403, which would help find the optimal turning rate depending on the mass of compost pile, as sensed by variations in the sensors 401 and 402

It will thus be seen that the objects set forth above, apparent from the preceding description and figures, are efficiently attained and, because certain changes may be easily made by those skilled in the art in carrying out the above method and in the construction(s) set forth without departing from the spirit and scope of the invention, it is intended that all matter contained in the above description and shown in the accompanying drawings shall be interpreted as illustrative, and not in a limiting sense.

1. A composter assembly consisting of:
a bin that is a housing and a structural member supporting a header which forms the top enclosure of the bin, semi-cylindrical container holding the compost pile, and a shaft sub-assembly, with the aforementioned header providing means to externally connect an instrument panel, a lid and receptacle for replaceable cartridge of humidity management particles, said header also allows attachment of a chute assembly and an air induction mechanism on the inside;
a slicer sub-assembly formed by a chute which has vertical cylinder intersecting with an inclined cylinder with the vertical cylinder containing a stationary blade and a slicer cylinder with multitude of blades and elliptical openings along the periphery of cylindrical surface;
a shaft sub-assembly directly driven externally has aerating scoops attached to the shaft and at least two gears to drive the slicer assembly through a splined joint;
a tray that collects formed compost that slides in a rectangular opening; and
a collection of sensors to measure humidity, temperature of the enclosed air, temperature of the compost pile and weight of the compost pile, displayed by a controller on instrument panel, whereby the said five pieces are assembled together to form the claimed composter assembly.

2. The composter assembly of claim 1, where the air induction mechanism is driven by a cam integrated within the bolt head assembling driving gear to slicer assembly.

3. A method to alert user tor turn the compost pile to achieve optimal aeration based on environmental conditions, as measured by temperature and humidity sensors and weight of the compost pile measured by the weight sensors in the assembly of claim 1.
